(19) United States
(12) Patent Application Publication
(10) Pub. No.: US 2021/0048186 A1
(43) Pub. Date: Feb. 18, 2021

(54) HEAT SINK FOR A MOUNTED ELEMENT

(71) Applicant: IDEA MACHINE DEVELOPMENT DESIGN AND PRODUCTION LTD., Rehovot (IL)

(72) Inventors: Shlomo TURGEMAN, Rishon Letzion (IL); Yonatan BRESLER, Neve Yerek (IL)

(21) Appl. No.: 16/980,458

(22) PCT Filed: Mar. 12, 2019
(86) PCT No.: PCT/IB2019/052019

§ 371 Date: Sep. 14, 2020

Related U.S. Application Data
(60) Provisional application No. 62/641,908, filed on Mar. 12, 2018.

(51) Int. Cl. F21V 29/71; F21V 29/76

(52) U.S. Cl. CPC F21V 29/713; F21V 29/80; F21V 29/76

(57) ABSTRACT

A heat sink for cooling an element mounted thereon, the heat sink kit including a first plate, a second plate, and an intermediate plate disposed between the first and second plates. The first, second, and intermediate plates are configured such that the relative location of the first and second plates can be adjusted in three dimensions.

### BACKGROUND

Mechanical systems often include subsystems that become heated during operation. This heat must be dissipated in order to maintain proper operation of the subsystem and/or the mechanical system. This is often achieved using a heat sink, a structure which facilitates the transfer of heat away from the subsystem. In some instances, such as in systems that utilize optical elements, the system must be calibrated before use, but it may be important that the position of the subsystem be maintained accurately after calibration. Thus there is a need for a heat sink which allows multiple degrees of freedom during assembly and/or calibration, but can be maintained in an accurate position thereafter and will conduct heat effectively.

### SUMMARY

There is provided in accordance with an embodiment of the invention a heat sink kit including:

a first plate including a first plurality of elongate leaves, the elongate leaves of the first plurality being arranged in a first direction;

a second plate, including a second plurality of elongate leaves, the elongate leaves of the second plurality being arranged in a second direction, transverse to the first direction;

an intermediate plate including a first layer having a third plurality of elongate leaves and a second layer having a fourth plurality of elongate leaves, the elongate leaves of the third plurality being arranged in the first direction and the elongate leaves of the fourth plurality being arranged in the second direction,

wherein the elongate leaves of the first plurality are constructed and operative to be interlaced with the elongate leaves of the third plurality, and the elongate leaves of the second plurality are constructed and operative to be interlaced with the elongate leaves of the fourth plurality; and

first and second locking assemblies adapted to lock a position of the interlaced leaves,

wherein, prior to locking the position of the interlaced leaves, a relative orientation between the first and second plates is adjustable in three dimensions.

In some embodiments, the elongate leaves of the first plurality are interlaced with the elongate leaves of the third plurality.

In some embodiments, the first locking assembly locks a relative position of the interlaced elongate leaves of the first and third pluralities.

In some embodiments, the elongate leaves of the second plurality are interlaced with the elongate leaves of the fourth plurality.

In some embodiments, the second locking assembly locks a relative position of the interlaced elongate leaves of the second and fourth pluralities.

In some embodiments, the leaves in the first plurality have a fixed first thickness, and each pair of adjacent leaves in the first plurality have a fixed first distance therebetween.

In some embodiments, the leaves in the third plurality have a fixed third thickness, and each pair of adjacent leaves in the third plurality have a fixed third distance therebetween, the third thickness being equal to or smaller than the first distance, and the third distance being equal to or greater than the first thickness.

In some embodiments, the leaves in the second plurality have a fixed second thickness, and each pair of adjacent leaves in the second plurality have a fixed second distance therebetween.

In some embodiments, the leaves in the fourth plurality have a fixed fourth thickness, and each pair of adjacent leaves in the fourth plurality have a fixed fourth distance therebetween, the fourth thickness being equal to or smaller than the second distance, and the fourth distance being equal to or greater than the second thickness.

In some embodiments, at least one of the first, second, third, and fourth thicknesses is in the range of 0.4 mm to 0.7 mm. In some embodiments, at least one of the first, second, third, and fourth thicknesses is 0.4 mm, 0.45 mm, 0.5 mm, 0.55 mm, 0.6 mm, 0.65 mm, or 0.7 mm. In some embodiments, at least one of the first, second, third, and fourth distances is in the range of 0.41 mm to 0.8 mm. In some embodiments, at least one of the first, second, third, and fourth distances 0.41 mm, 0.45 mm, 0.5 mm, 0.55 mm, 0.6 mm, 0.65 mm, 0.7 mm, 0.75 mm, or 0.8 mm.

In some embodiments, each of the elongate leaves of the first and third pluralities includes at least one bore, wherein bores of the elongated leaves of the first and third pluralities are alignable with one another, and wherein the first locking assembly includes at least one elongate rod adapted to extend through the bores of the interlaced leaves of the first and third pluralities when the bores are aligned, and to be locked therein, thereby to fix the relative position of the first plate and the intermediate plate.

In some embodiments, the first locking assembly further includes locking rulers adapted to lock the at least one elongate rod within the bores and to apply pressure to the interlaced leaves of the first and third pluralities, such that the interlaced leaves of the first and third pluralities contact one another.

In some embodiments, the first locking assembly further includes locking rulers including bores adapted accommodate the at least one elongate rod and nuts adapted to lock the at least one elongate rod within the bores and the locking rulers, the locking rulers adapted to apply pressure to the interlaced leaves of the first and third pluralities, such that the interlaced leaves of the first and third pluralities contact one another.

In some embodiments, each of the elongate leaves of the second and fourth pluralities includes at least one bore, wherein bores of the elongated leaves of the second and fourth pluralities are alignable with one another, and wherein the second locking assembly includes at least one elongate rod adapted to extend through the bores of the interlaced leaves of the second and fourth pluralities when the bores are aligned, and to be locked therein, thereby to fix the relative position of intermediate plate and the second plate.

In some embodiments, the second locking assembly further includes locking rulers adapted to lock the at least one elongate rod within the bores and to apply pressure to the interlaced leaves of the second and fourth pluralities, such that the interlaced leaves of the second and fourth pluralities contact one another.

In some embodiments, the second locking assembly further includes locking rulers including bores adapted accommodate the at least one elongate rod and nuts adapted to lock the at least one elongate rod within the bores and the locking rulers, the locking rulers adapted to apply pressure to the interlaced leaves of the second and fourth pluralities, such that the interlaced leaves of the second and fourth pluralities contact one another.

In some embodiments, the first plate, the second plate, and the intermediate plate are formed of a heat conducting material.

In some embodiments, the first, second, and intermediate plates are all formed of the same heat conducting material.

In some embodiments, each of the first, second, and intermediate plates is formed of a different heat conducting material.

In some embodiments, at least two of the first, second, and intermediate plates are formed of the same heat conducting material.

In some embodiments, the heat conducting material has a conductivity in the range of 100 W/mK to 500 W/mK, 150 W/mK to 450 W/mK, or 200 W/mK to 400 W/mK.

In some embodiments, a heat conductivity of at least one of the first and second locking assemblies is less than a heat conductivity of at least one of the first, second, and intermediate plates.

In some embodiments, the heat conducting material is a metal or an alloy. In some embodiments, the heat conducting metal or alloy includes at least one of aluminum and copper.

In some embodiments, the first plate and the first plurality of leaves are manufactured together as an integrally formed unit. In some embodiments, the second plate and the second plurality of leaves are manufactured together as an integrally formed unit. In some embodiments, the intermediate plate and the third and fourth pluralities of leaves are manufactured together as an integrally formed unit.

In some embodiments, the heat sink kit further includes an anchoring arrangement for anchoring the first plate to an anchoring surface.

In some embodiments, the heat sink kit further includes a mounting arrangement for mounting an element to be cooled during use onto a face of the second plate distal to the first plate.

In accordance with another embodiment of the invention there is provided a kit including:

the heat sink kit as described hereinabove; and

an element to be cooled during use, adapted to be mounted onto a face of one of the first and the second plates,

wherein the heat sink kit is adapted to remove heat from the element.

In some embodiments, the element to be cooled during use includes an optical element.

In accordance with a further embodiment of the invention, there is provided a method of constructing a heat sink for cooling a mounted element, using the heat sink kit as described hereinabove, the method including at least one of:

using the first locking assembly to lock a relative position of the first and third plates; and

using the second locking assembly to lock a relative position of the second and third plates.

In accordance with an embodiment of the invention, the method includes both using the first locking assembly to lock a relative position of the first and third plates; and using the second locking assembly to lock a relative position of the second and third plates.

In accordance with an embodiment of the invention, the method further includes at least one of

interlacing the elongate leaves of the first and third pluralities prior to using the first locking assembly to lock a relative position of the first and third plates; and

interlacing the elongate leaves of the second and fourth pluralities prior to using the second locking assembly to lock a relative position of the second and third plates.

In accordance with an embodiment of the invention, the method includes both interlacing the elongate leaves of the first and third pluralities prior to using the first locking assembly to lock a relative position of the first and third plates; and interlacing the elongate leaves of the second and fourth pluralities prior to using the second locking assembly to lock a relative position of the second and third plates.

In accordance with an embodiment of the invention, the method of constructing a heat sink for cooling a mounted element, using the heat sink kit as described hereinabove includes:

interlacing the elongate leaves of the first and third pluralities;

using the first locking assembly to lock a relative position of the first and third plates;

interlacing the elongate leaves of the second and fourth pluralities;

using the second locking assembly to lock a relative position of the second and third plates.

In some embodiments, the method further includes mounting the element onto a face of the second plate, optionally using the mounting arrangement to do so.

In accordance with another embodiment of the invention, there is provided a method of constructing a heat sink for cooling an element using the heat sink kit hereinabove, the method including at least one of:

(a) using the first locking assembly to lock a relative position of the first and third plates, and (b) using the second locking assembly to lock a relative position of the second and third plates; and

mounting the element onto a face of the second plate using the mounting arrangement.

In some embodiments, the method includes both using the first locking assembly to lock a relative position of the first and third plates; and using the second locking assembly to lock a relative position of the second and third plates.

In accordance with some embodiments, the method further includes at least one of:

interlacing the elongate leaves of the first and third pluralities prior to using the first locking assembly to lock a relative position of the first and third plates; and

interlacing the elongate leaves of the second and fourth pluralities prior to using the second locking assembly to lock a relative position of the second and third plates.

In accordance with some embodiments, the method includes both interlacing the elongate leaves of the first and third pluralities prior to using the first locking assembly to lock a relative position of the first and third plates; and interlacing the elongate leaves of the second and fourth pluralities prior to using the second locking assembly to lock a relative position of the second and third plates.

In some embodiments, the method includes:

interlacing the elongate leaves of the first and third pluralities;

using the first locking assembly to lock a relative position of the first and third plates;

interlacing the elongate leaves of the second and fourth pluralities;

using the second locking assembly to lock a relative position of the second and third plates; and

mounting the element onto a face of the second plate using the mounting arrangement.

In accordance with a further embodiment of the invention, there is provided a heat sink including:

a first plate including a first plurality of elongate leaves, the elongate leaves of the first plurality being arranged in a first direction;

a second plate, including a second plurality of elongate leaves, the elongate leaves of the second plurality being arranged in a second direction, transverse to the first direction;

an intermediate plate including a first layer having a third plurality of elongate leaves and a second layer having a fourth plurality of elongate leaves, the elongate leaves of the third plurality being arranged in the first direction and the elongate leaves of the fourth plurality being arranged in the second direction,

wherein the elongate leaves of the first plurality are interlaced with the elongate leaves of the third plurality, and the elongate leaves of the second plurality are interlaced with the elongate leaves of the fourth plurality;

a first locking assembly locking a relative position of the interlaced elongate leaves of the first and third pluralities; and

a second locking assembly locking a relative position of the interlaced elongate leaves of the second and fourth pluralities.

In some embodiments, prior to locking the position of the interlaced leaves, a relative orientation between the first and second plates is adjustable in three dimensions.

In some embodiments, the leaves in the first plurality have a fixed first thickness, and each pair of adjacent leaves in the first plurality have a fixed first distance therebetween.

In some embodiments, the leaves in the third plurality have a fixed third thickness, and each pair of adjacent leaves in the third plurality have a fixed third distance therebetween, the third thickness being equal to or smaller than the first distance, and the third distance being equal to or greater than the first thickness.

In some embodiments, the leaves in the second plurality have a fixed second thickness, and each pair of adjacent leaves in the second plurality have a fixed second distance therebetween.

In some embodiments, the leaves in the fourth plurality have a fixed fourth thickness, and each pair of adjacent leaves in the fourth plurality have a fixed fourth distance therebetween, the fourth thickness being equal to or smaller than the second distance, and the fourth distance being equal to or greater than the second thickness.

In some embodiments, at least one of the first, second, third, and fourth thicknesses is in the range of 0.4 mm to 0.7 mm. In some embodiments, at least one of the first, second, third, and fourth thicknesses is 0.4 mm, 0.45 mm, 0.5 mm, 0.55 mm, 0.6 mm, 0.65 mm, or 0.7 mm.

In some embodiments, at least one of the first, second, third, and fourth distances is in the range of 0.41 mm to 0.8 mm. In some embodiments, at least one of the first, second, third, and fourth distances 0.41 mm, 0.45 mm, 0.5 mm, 0.55 mm, 0.6 mm, 0.65 mm, 0.7 mm, 0.75 mm, or 0.8 mm.

In some embodiments, each of the elongate leaves of the first and third pluralities includes at least one bore, wherein bores of the elongated leaves of the first and third pluralities are aligned with one another, and wherein the first locking assembly includes at least one elongate rod extending through the bores of the interlaced leaves of the first and third pluralities and locked therein, thereby fixing the relative position of the first plate and the intermediate plate.

In some embodiments, the first locking assembly further includes locking rulers locking the at least one elongate rod within the bores and applying pressure to the interlaced leaves of the first and third pluralities, such that the interlaced leaves of the first and third pluralities contact one another.

In some embodiments, the first locking assembly further includes locking rulers including bores accommodating the at least one elongate rod and nuts locking the at least one elongate rod within the bores and the locking rulers, the locking rulers applying pressure to the interlaced leaves of the first and third pluralities, such that the interlaced leaves of the first and third pluralities contact one another.

In some embodiments, each of the elongate leaves of the second and fourth pluralities includes at least one bore, wherein bores of the elongated leaves of the second and fourth pluralities are aligned with one another, and wherein the second locking assembly includes at least one elongate rod extending through the bores of the interlaced leaves of the second and fourth pluralities and locked therein, thereby fixing the relative position of intermediate plate and the second plate.

In some embodiments, the second locking assembly further includes locking rulers locking the at least one elongate rod within the bores and applying pressure to the interlaced leaves of the second and fourth pluralities, such that the interlaced leaves of the second and fourth pluralities contact one another.

In some embodiments, the second locking assembly further includes locking rulers including bores accommodating the at least one elongate rod and nuts locking the at least one elongate rod within the bores and the locking rulers, the locking rulers applying pressure to the interlaced leaves of the second and fourth pluralities, such that the interlaced leaves of the second and fourth pluralities contact one another.

In some embodiments, the first plate, the second plate, and the intermediate plate are formed of a heat conducting material.

In some embodiments, the first, second, and intermediate plates are all formed of the same heat conducting material.

In some embodiments, each of the first, second, and intermediate plates is formed of a different heat conducting material.

In some embodiments, at least two of the first, second, and intermediate plates are formed of the same heat conducting material.

In some embodiments, the heat conducting material has a conductivity in the range of 100 W/mK to 500 W/mK, 150 W/mK to 450 W/mK, or 200 W/mK to 400 W/mK. In some embodiments, a heat conductivity of at least one of the first and second locking assemblies is less than a heat conductivity of at least one of the first, second, and intermediate plates.

In some embodiments, the heat conducting material is a metal or an alloy. In some embodiments, the heat conducting metal or alloy includes at least one of aluminum and copper.

In some embodiments, the first plate and the first plurality of leaves are manufactured together as an integrally formed unit. In some embodiments, the second plate and the second plurality of leaves are manufactured together as an integrally formed unit. In some embodiments, the intermediate plate and the third and fourth pluralities of leaves are manufactured together as an integrally formed unit.

In some embodiments, the heat sink further includes an anchoring arrangement for anchoring the first plate to an anchoring surface.

In some embodiments, the heat sink further includes a mounting arrangement for mounting an element to be cooled during use onto a face of the second plate distal to the first plate.

In some embodiments, the heat sink further includes an element to be cooled during use mounted thereupon.

In accordance with another embodiment of the invention, there is provided a kit including:

the heat sink as described herein; and

an element to be cooled during use, adapted to be mounted onto a face of one of the first and the second plates,

wherein the heat sink kit is adapted to remove heat from the element.

In some embodiments, the element to be cooled during use includes an optical element.

Unless otherwise defined, all technical and scientific terms used herein have the same meaning as commonly understood by one of ordinary skill in the art to which the invention pertains. In case of conflict, the specification, including definitions, will take precedence.

As used herein, the terms “comprising”, “including”, “having” and grammatical variants thereof are to be taken as specifying the stated features, integers, steps or components but do not preclude the addition of one or more additional features, integers, steps, components or groups thereof. These terms encompass the terms “consisting of” and “consisting essentially of”.

As used herein, the indefinite articles “a” and “an” mean “at least one” or “one or more” unless the context clearly dictates otherwise.

### BRIEF DESCRIPTION OF THE FIGURES

Some embodiments of the invention are described herein with reference to the accompanying figures. The description, together with the figures, makes apparent to a person having ordinary skill in the art how some embodiments of the invention may be practiced. The figures are for the purpose of illustrative discussion and no attempt is made to show structural details of an embodiment in more detail than is necessary for a fundamental understanding of the invention. For the sake of clarity, some objects depicted in the figures are not to scale.

In the Figures:

FIG. 1 is an exploded view perspective illustration of a heat sink in accordance with an embodiment of the teachings herein;

FIGS. 2A and 2B are, respectively, a perspective view illustration and a sectional illustration of the heat sink of FIG. 1 in assembled form, the sectional illustration taken along section lines IIB-IIB in FIG. 2A; and

FIGS. 3A and 3B are side view planar illustrations of the heat sink of FIG. 1, having a top surface thereof tilted according to an embodiment of the teachings herein.

### DESCRIPTION OF SOME EMBODIMENTS OF THE INVENTION

There is provided a heat sink, for maintaining the accurate positioning of an element mounted thereon, such as an optical element. The pose of the heat sink is adjustable, allowing for accurate three dimensional positioning of the optical element, and is lockable in a selected position so as to ensure that the positioning of the optical element remains stable.

The heat sink described herein is adapted to absorb heat from a nearby element to help disperse the heat. As will be explained further, the nearby element may be mounted on the heat sink, for example it may be an optical element mounted on the heat sink and the heat sink may be mounted onto a base and may transfer heat from the optical element to the base.

The principles, uses and implementations of the teachings herein may be better understood with reference to the accompanying description and figures. Upon perusal of the description and figures present herein, one skilled in the art is able to implement the invention without undue effort or experimentation.

Before explaining at least one embodiment of the invention in detail, it is to be understood that the invention is not limited in its applications to the details of construction and the arrangement of the components and/or methods set forth in the following description and/or illustrated in the drawings and/or the Examples. The invention can be implemented with other embodiments and can be practiced or carried out in various ways. It is also understood that the phraseology and terminology employed herein is for descriptive purpose and should not be regarded as limiting.

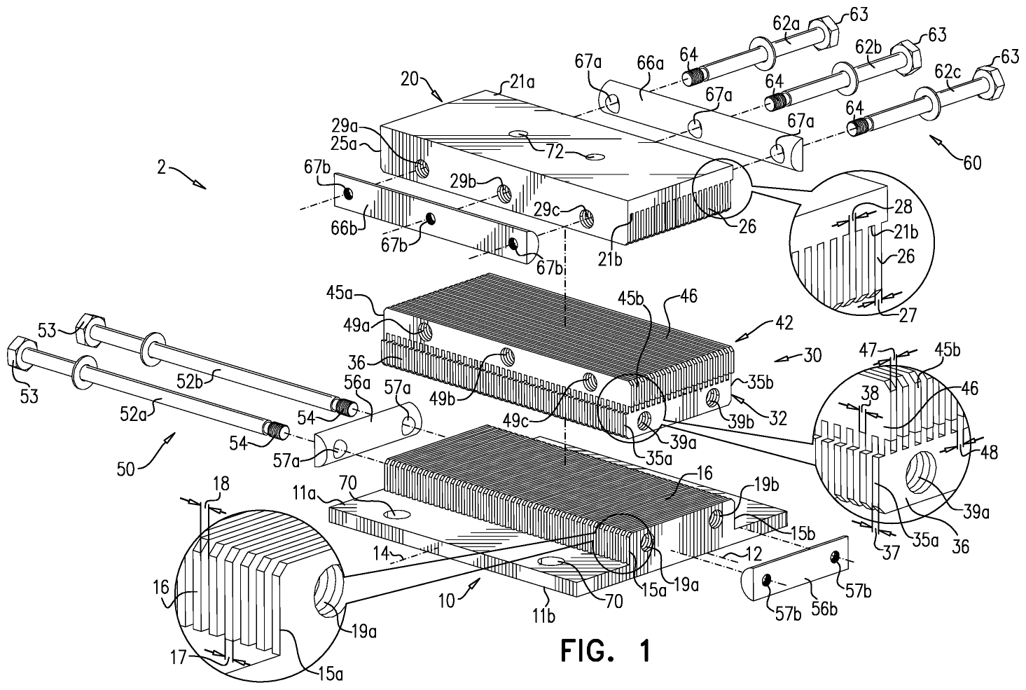

Reference is now made to FIG. 1, which is an exploded view perspective illustration of a heat sink 2 in accordance with an embodiment of the teachings herein.

As seen in FIG. 1, the heat sink 2 includes a first heat conductive plate 10, having an upper face 11a, a lower face 11b, a lengthwise axis 12 and a widthwise axis 14. Plate 10 includes a first plurality of elongate leaves 16 extending generally perpendicularly from face 11 parallel to one another, each leaf 16 having a first edge 15a and a second edge 15b. In some embodiments, the leaves 16 are all of the same thickness, here shown as a thickness 17. In some embodiments, each pair of adjacent leaves 16 are spaced from one another by a fixed distance 18, that is approximately equal to or slightly larger than thickness 17. Leaves 16 are all arranged in a first direction, here shown as being arranged parallel to widthwise axis 14 of plate 10.

In some embodiments, plate 10 and leaves 16 are formed of a metal, such as copper or aluminum.

In some embodiments, plate 10 and leaves 16 are formed of a heat conductive material having a conductivity in the range of 100 W/mK to 500 W/mK, 150 W/mK to 450 W/mK, or 200 W/mK to 400 W/mK.

In some embodiments, the thickness 17 is in the range of 0.4 mm to 0.7 mm, e.g. 0.4 mm, 0.45 mm, 0.5 mm, 0.55 mm, 0.6 mm, 0.65 mm, or 0.7 mm. In some embodiments, the distance 18 is in the range of 0.41 mm to 0.8 mm, e.g. 0.41 mm, 0.45 mm, 0.5 mm, 0.55 mm, 0.6 mm, 0.65 mm, 0.7 mm, 0.75 mm, or 0.8 mm.

Each of the leaves 16 includes bores 19a and 19b, the bores being arranged such that all the bores 19a of all the leaves 16 are aligned with one another and all the bores 19b of all the leaves are aligned with one another, the axes along which the respective groups of bores are aligned being parallel to one another and parallel to lengthwise axis 12 of plate 10. The distance between the axes of the bores may vary, but generally speaking each set of bores will be located about one eighth to one third of the distance from one of edges 15a and 15b to the other edge.

In some embodiments, all the bores 19a and 19b have an equal diameter. In some embodiments, all the bores 19a have a first equal diameter, all the bores 19b have a second equal diameter, the first and second diameters being different from one another. In other embodiments, bores 19a of different leaves 16 may have differing diameters and/or bores 19b of different leaves 16 may have differing diameters. For example, a few (e.g. five) of bores 19a and/or a few (e.g. five) of bores 19b may have a first, smaller diameter, while the rest of bores 19a and 19b have a second, larger diameter. In some cases, the smaller bores may be located in leaves that are adjacent one another, for example in the leaves 16 at one end of the plate 10, whereas in other cases the smaller bores may be dispersed among the leaves 16. As another example, the bores 19a and/or 19b may be of increasing diameter along an axis of alignment of the bores, such that the hollow formed by the collection of bores is tapered.

Though the illustrated embodiment shows two bores 19a and 19b in each leaf, one of ordinary skill in the art would appreciate that any suitable number of bores, typically at least two, may be used. It is appreciated that though bores 19a and 19b are illustrated as circular bores, the bores may have any suitable cross section, for example an elliptical cross section, a square cross section, and the like.

In some embodiments, plate 10 and leaves 16 are manufactured as a single unit, for example by casting or molding, while in other embodiments leaves 16 are manufactured separately, and are then connected to face 11a of plate 10 in a manner that facilitates heat conduction between the leaves 16 and the main body of the plate.

Heat sink 2 further includes a second heat conductive plate 20, having an upper face 21a and a lower face 21b. Plate 20 includes a second plurality of elongate leaves 26 extending generally perpendicularly from face 21b parallel to one another, each leaf 26 having a first edge 25a and a second edge 25b. In some embodiments, the leaves 26 are all of the same thickness, here shown as thickness 27. In some embodiments, each pair of adjacent leaves are spaced from one another by a fixed distance 28 that is approximately equal to or slightly larger than thickness 27. Leaves 26 are all arranged in a second direction transverse to the first direction, here shown as being arranged parallel to the lengthwise axis 12 of first plate 10.

In some embodiments, plate 20 and leaves 26 are formed of a metal, such as copper or aluminum.

In some embodiments, plate 20 and leaves 26 are formed of a heat conductive material having a conductivity in the range of 100 W/mK to 500 W/mK, 150 W/mK to 450 W/mK, or 200 W/mK to 400 W/mK.

In some embodiments, the thickness 27 is in the range of 0.4 mm to 0.7 mm, e.g. 0.4 mm, 0.45 mm, 0.5 mm, 0.55 mm, 0.6 mm, 0.65 mm, or 0.7 mm. In some embodiments, the distance 28 is in the range of 0.41 mm to 0.8 mm, e.g. 0.41 mm, 0.45 mm, 0.5 mm, 0.55 mm, 0.6 mm, 0.65 mm, 0.7 mm, 0.75 mm, or 0.8 mm.

Each of the leaves 26 includes bores 29a, 29b, and 29c, the bores being arranged such that all the bores 29a of all the leaves are aligned with one another, all the bores 29b of all the leaves are aligned with one another, and all the bores 29c of all the leaves are aligned with one another. The axes along which the respective groups of bores 29a, 29b, and 29c are aligned are parallel to one another and parallel to the widthwise axis 14 of first plate 10. The distance between the axes of the sets of bores 29a, 29b and 29c may vary, but generally speaking the outermost sets of bores will be located about one eighth to one third of the distance from one of edges 25a and 25b to the other edge, and the middle set of bores will be approximately equidistant from the edges.

In some embodiments, all the bores 29a, 29b, and 29c have an equal diameter. In some embodiments, all the bores 29a have a first equal diameter, all the bores 29b have a second equal diameter, and all the bores 29c have a third equal diameter, at least two of the first, second, and third diameters being different from one another. In other embodiments, bores 29a of different leaves 26 may have differing diameters, bores 29b of different leaves 26 may have differing diameters, and/or bores 29c of different leaves 26 may have differing diameters. For example, a few (e.g. five) of bores 29a, a few (e.g. five) of bores 29b, and/or a few (e.g. five) of bores 29c may have a first, smaller diameter, while the rest of bores 29a, 29b, and 29c have a second, larger diameter. In some cases, the smaller bores may be located in leaves that are adjacent one another, for example in the leaves 26 at one end of the plate 20, whereas in other cases the smaller bores may be dispersed among the leaves 26. As another example, the bores 29a, 29b, and/or 29c may be of increasing diameter along an axis of alignment of the bores, such that the hollow formed by the collection of bores is tapered.

Though the illustrated embodiment shows three bores 29a, 29b, and 29c in each leaf, one of ordinary skill in the art would appreciate that any suitable number of bores, typically at least two, may be used.

It is appreciated that though bores 29a, 29b, and 29c are illustrated as circular bores, the bores may have any suitable cross section, for example an elliptical cross section, a square cross section, and the like.

In some embodiments, plate 20 and leaves 26 are manufactured as a single unit, for example by casting or molding, while in other embodiments leaves 26 are manufactured separately, and are then connected to face 21b of plate 20 in a manner that facilitates heat conduction between the leaves 26 and the main body of the plate.

An intermediate heat conductive plate 30 includes a first layer 32 having a third plurality of elongate leaves 36 extending in one direction, each leaf 36 having a first edge 35a and a second edge 35b. The leaves 36 are parallel to each other and are arranged in the first direction, here shown as parallel to widthwise axis 14. In some embodiments, the leaves 36 are all of the same thickness, here shown as thickness 37, that is not more than the distance 18 between leaves 16 of first plate 10. In some embodiments, each two adjacent leaves 36 are spaced apart from each other by a fixed distance 38 that is approximately equal to or slightly larger than thickness 17 of leaves 16 of the first plate 10.

In some embodiments, the thickness 37 is in the range of 0.4 mm to 0.7 mm, e.g. 0.4 mm, 0.45 mm, 0.5 mm, 0.55 mm, 0.6 mm, 0.65 mm, or 0.7 mm. In some embodiments, the distance 38 is in the range of 0.41 mm to 0.8 mm, e.g. 0.41 mm, 0.45 mm, 0.5 mm, 0.55 mm, 0.6 mm, 0.65 mm, 0.7 mm, 0.75 mm, or 0.8 mm.

Each of the leaves 36 includes bores 39a and 39b, the bores being arranged such that all the bores 39a of all the leaves 36 are aligned with one another and all the bores 39b of all the leaves are aligned with one another, the axes along which the respective groups of bores are aligned being parallel to one another and being parallel to lengthwise axis 12. The distance between the axes of the bores 39a and 39b may vary, but generally speaking each set of bores 39a and 39b will be located about one eighth to one third of the distance from one edge of the leaves to the other edge, with the axes of the sets of bores 39a and 39b being spaced from each other with the same spacing as exists between the axes of the sets of bores 19a and 19b, so as to facilitate alignment of the bores 19a and 39a, and of the bores 19b and 39b, as described in greater detail hereinbelow.

In some embodiments, all the bores 39a and 39b have the same diameter, which, in some embodiments, is equal to the diameter of bores 19a and 19b. In some embodiments, all the bores 39a have a first equal diameter, and all the bores 39b have a second equal diameter, the first and second diameters being different from one another. In some such embodiments, the first diameter of bores 39a is equal to the first diameter of bores 19a, and/or the second diameter of bores 39b is equal to the second diameter of bores 19b. In other embodiments, bores 39a of different leaves 36 may have differing diameters and/or bores 39b of different leaves 36 may have differing diameters. For example, a few (e.g. five) of bores 39a and/or a few (e.g. five) of bores 39b may have a first, smaller diameter, while the rest of bores 39a and 39b have a second, larger diameter. In some cases, the smaller bores may be located on leaves that are adjacent one another, for example in the leaves 36 at one end of the plate 30, whereas in other cases the smaller bores may be dispersed among the leaves 36. As another example, the bores 39a and/or 39b may be of increasing diameter along an axis of alignment of the bores, such that the hollow formed by the collection of bores is tapered.

Intermediate heat conductive plate 30 further includes a second layer 42, having a fourth plurality of elongate leaves 46 which extend outwardly in the direction opposite to the direction in which leave 36 extend, each leaf having a first edge 45a and a second edge 45b. The leaves 46 are parallel to each other and are arranged in the second direction, here shown as parallel to lengthwise axis 12. Each of leaves 46 has a thickness 47 which is not more than the distance 28 between leaves 26 of second plate 20. Each two adjacent leaves 46 are spaced apart from each other by a distance 48 that is approximately equal to or slightly larger than thickness 27 of leaves 26 of the second plate 20.

In some embodiments, the thickness 47 is in the range of 0.4 mm to 0.7 mm, e.g. 0.4 mm, 0.45 mm, 0.5 mm, 0.55 mm, 0.6 mm, 0.65 mm, or 0.7 mm. In some embodiments, the distance 48 is in the range of 0.41 mm to 0.8 mm, e.g. 0.41 mm, 0.45 mm, 0.5 mm, 0.55 mm, 0.6 mm, 0.65 mm, 0.7 mm, 0.75 mm, or 0.8 mm.

Each of the leaves 46 includes bores 49a, 49b, and 49c, the bores being arranged such that all the bores 49a of all the leaves 46 are aligned with one another, all the bores 49b of all the leaves are aligned with one another, and all the bores 49c of all the leaves are aligned with one another, the axes along which the respective groups of bores are aligned being parallel to one another and being parallel to widthwise axis 14. The distance between the axes of the sets of bores 49a, 49b and 49c may vary, but generally speaking the outermost sets of bores will be located about one eighth to one third of the distance from one of edges 45a and 45b to the other edge, and the middle set of bores will be approximately equidistant from the edges, with the axes of the sets of bores 49a, 49b, and 49c being respectively spaced from each other with the same spacing as exists between the axes of the sets of bores 29a, 29b, and 29c, so as to facilitate alignment of the bores 29a and 49a, of bores 29b and 49b, and of the bores 29c and 49c, as described in greater detail hereinbelow.

In some embodiments, all the bores 49a, 49b, and 49c have the same diameter, which may be equal to a diameter of bores 29a, 29b, and 29c. In some embodiments, all the bores 49a have a first equal diameter, all the bores 49b have a second equal diameter, and all the bores 49c have a third equal diameter, at least two of the first, second, and third diameters being different from one another. In some such embodiments, the first diameter of bores 49a is equal to the first diameter of bores 29a, the second diameter of bores 49b is equal to the second diameter of bores 29b, and/or the third diameter of bores 49c is equal to the third diameter of bores 29c. In other embodiments, bores 49a of different leaves 46 may have differing diameters, bores 49b of different leaves 46 may have differing diameters, and/or bores 49c of different leaves 46 may have differing diameters. For example, a few (e.g. five) of bores 49a, a few (e.g. five) of bores 49b, and/or a few (e.g. five) of bores 49c may have a first, smaller diameter, while the rest of bores 49a, 49b, and 49c have a second, larger diameter. In some cases, the smaller bores may be located on leaves that are adjacent one another, for example in the leaves 46 at one end of the plate 30, whereas in other cases the smaller bores may be dispersed among the leaves 46. As another example, the bores 49a, 49b, and/or 49c may be of increasing diameter along an axis of alignment of the bores, such that the hollow formed by the collection of bores is tapered.

Though the illustrated embodiment shows two bores 39a and 39b in each leaf 36, and three bores 49a, 49b, and 49c in each leaf 46, one of ordinary skill in the art would appreciate that any suitable number of bores may be used.

It is appreciated that though bores 39a, 39b, 49a, 49b, and 49c are illustrated as circular bores, the bores may have any suitable cross section, for example an elliptical cross section, a square cross section, and the like.

In some embodiments, plate 30 and leaves 36 and 46 are formed of a metal, such as copper or aluminum.

In some embodiments, plate 30 and leaves 36 and 46 are formed of a heat conductive material having a conductivity in the range of 100 W/mK to 500 W/mK, 150 W/mK to 450 W/mK, or 200 W/mK to 400 W/mK.

In some embodiments, plate 30, including leaves 36 and 46, is manufactured as a single unit, e.g. by casting or molding, while in other embodiments leaves 36 and the leaves 46 are manufactured separately, and are then connected to form plate 30.

Heat sink 2 further includes a first locking assembly 50 and a second locking assembly 60.

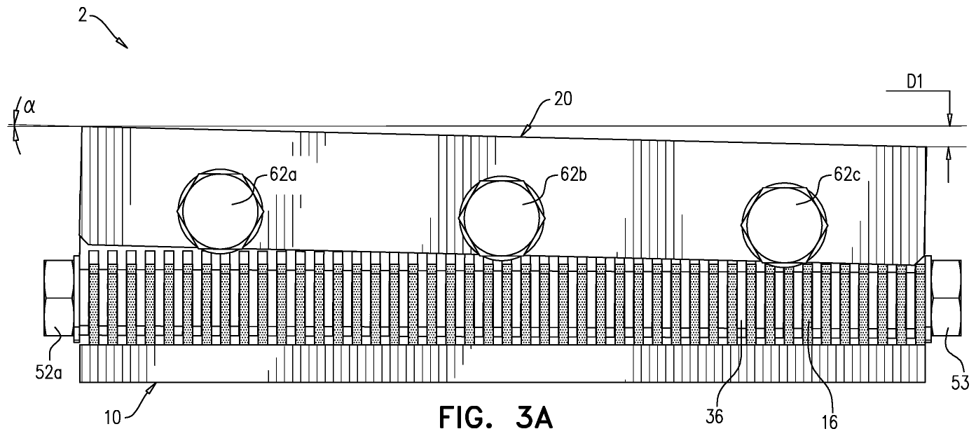

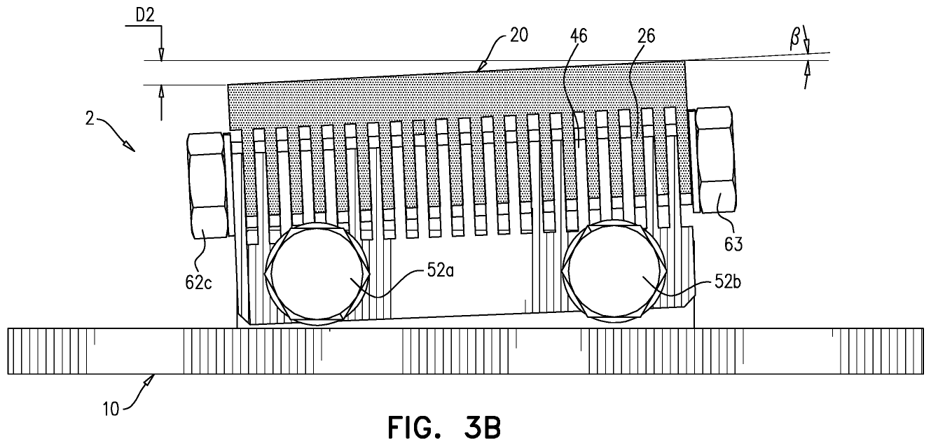

First locking assembly 50 includes two rods 52a and 52b, each terminating at one end thereof in a head 53 and at the other end thereof in a threaded portion 54. First locking assembly 50 further includes a pair of locking rulers 56a and 56b adapted to be disposed at opposing ends of the rods 52a and 52b. Rulers 56a and 56b each include bores 57a and 57b, respectively, adapted to accommodate rods 52a and 52b. In some embodiments, bores 57b of ruler 56b includes an internal thread, adapted to engage threaded portion 54 of rods 52a and 52b. In some embodiments, e.g. as shown in FIGS. 3A and 3B, threaded nuts (not shown) are adapted to engage threaded portions 54 of rods 52a and 52b, exterior to ruler 56b. As explained in further detail hereinbelow, rod 52a is sized and configured to fit within bores 19a and 39a, and rod 52b is sized and configured to fit within bores 19b and 39b. Specifically, in cases in which bores 19a, 19b, 39a, and/or 39b do not have circular cross sections, the rods 52a and 52b are sized and configured to fit within the aligned portions of the bores 19a and 39a, and 19b and 39b, respectively, regardless of the cross sectional shape of the bores. Furthermore, in cases in which the bores 19a and 39a, and/or 19b and 39b, are of differing sizes, rods 52a and 52b are sized and configured to fit through all the bores of the relevant group of bores.

Second locking assembly 60 includes three rods 62a, 62b, and 62c each terminating at one end thereof in a head 63 and at the other end thereof in a threaded portion 64. Second locking assembly 60 further includes a pair of locking rulers 66a and 66b adapted to be disposed at opposing ends of the rods 62a, 62b, and 62c. Rulers 66a and 66b each include bores 67a and 67b, respectively, adapted to accommodate rods 62a, 62b, and 62c. In some embodiments, bores 67b of ruler 66b includes an internal thread, adapted to engage threaded portion 64 of rods 62a, 62b, and 62c. In some embodiments, e.g. as shown in FIGS. 3A and 3B, threaded nuts (not shown) are adapted to engage threaded portions 64 of rods 62a, 62b, and 62c, exterior to ruler 66b. As explained in further detail hereinbelow, rod 62a is sized and configured to fit within bores 29a and 49a, rod 62b is sized and configured to fit within bores 29b and 49b, and rod 62c is sized and configured to fit within bores 29c and 49c. Specifically, in cases in which bores 29a, 29b, 29c, 49a, 49b, and/or 49c do not have circular cross sections, the rods 62a, 62b, and 62c are sized and configured to fit within the aligned portions of the bores 29a and 49a, 29b and 49b, and 29c and 49c, respectively, regardless of the cross sectional shape of the bores. Furthermore, in cases in which the bores 29a and 49a, 29b and 49b, and/or 29c and 49c are of differing sizes, rods 62a, 62b, and 62c are sized and configured to fit through all the bores of the relevant group of bores.

In some embodiments, the heat conductivity of locking assemblies 50 and 60 is smaller than the heat conductivity of plate 10, plate 20, and/or plate 30. In some embodiments, the heat conductivity of locking assemblies 50 and 60 is greater than the heat conductivity of plate 10, plate 20, and/or plate 30. In some embodiments, the heat conductivity of locking assemblies 50 and 60 is equal to the heat conductivity of plate 10, plate 20, and/or plate 30.

In some embodiments, first plate 10 has a larger footprint than second plate 20 and intermediate plate 30, such that leaves 16 do not cover the entire plate 10. In some embodiments, plate 10 includes an anchoring arrangement for anchoring the heat sink 2 to an anchoring surface. In some such embodiments, one or more bores 70 may be formed in the margins of plate 10, for anchoring of the plate 10 and of heat sink 2 to an anchoring surface, such as a table.

In some embodiments, plate 20 includes a mounting arrangement adapted for mounting an element to be cooled during use onto plate 20. In some such embodiments, face 21a of plate 20 includes one or more wells, protrusions or other structures, delineated as 72, which facilitates the mounting of an element, such as an optical element, thereon. It will be appreciated that if structures 72 are wells, it is preferable that they be of a depth that does not go all the way to face 21b of plate 20.

The dimensions of plates 10, 20, and 30 may be any dimensions suitable to support the element to be mounted onto face 21a of plate 20, and to sufficiently remove heat therefrom. In some embodiments, in which the mounted element comprises an optical element, for example of a microscopy system, the length of plates 20 and 30, and of a region of plate 10 excluding any margins, is in the range of 130 mm to 180 mm, e.g. 130 mm, 135 mm, 140 mm, 145 mm, 150 mm, 155 mm, 160 mm, 165 mm, 170 mm, 175 mm, or 180 mm. For example, the width of plates 20 and 30, and of a region of plate 10 excluding any margins, is in the range of 80 mm to 120 mm, e.g. 80 mm, 85 mm, 90 mm, 95 mm, 100 mm, 105 mm, 110 mm, 115 mm, or 120 mm.

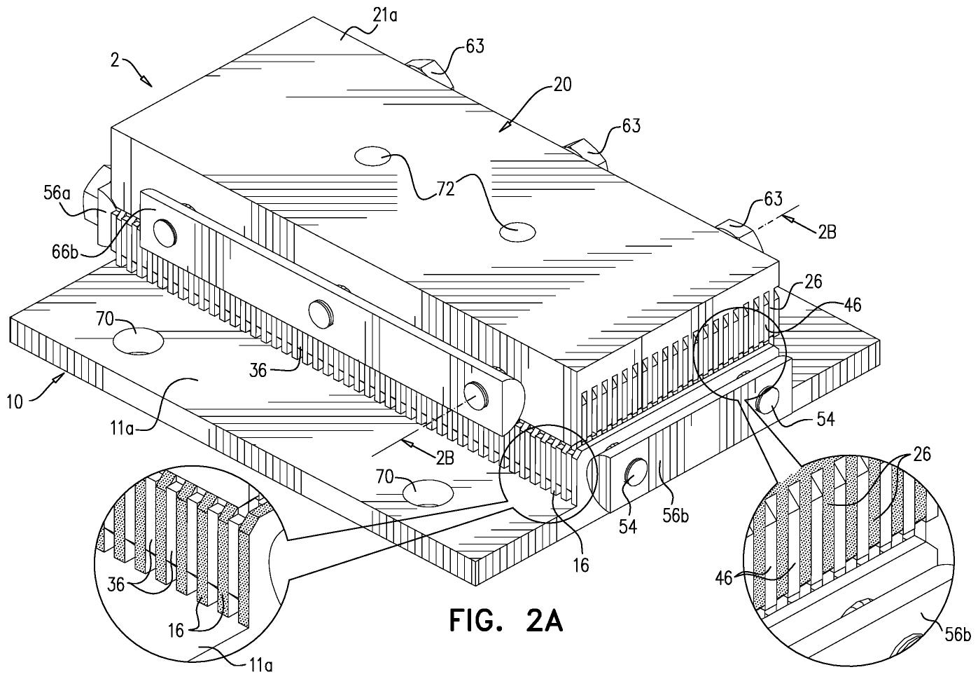

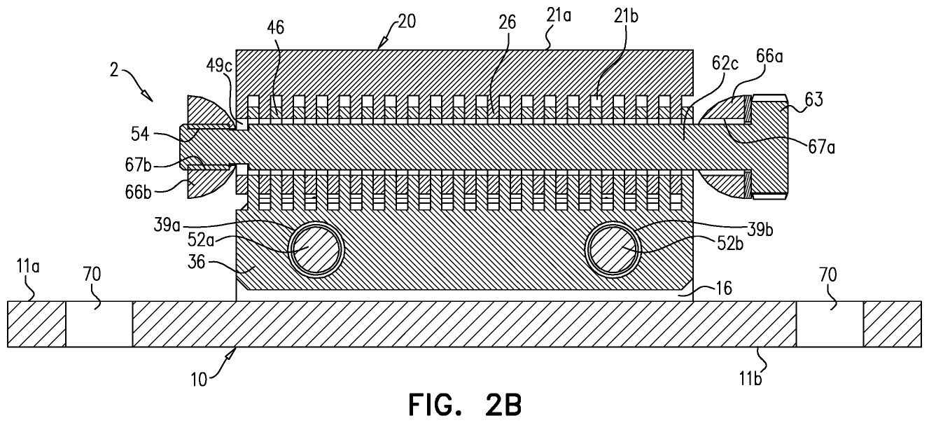

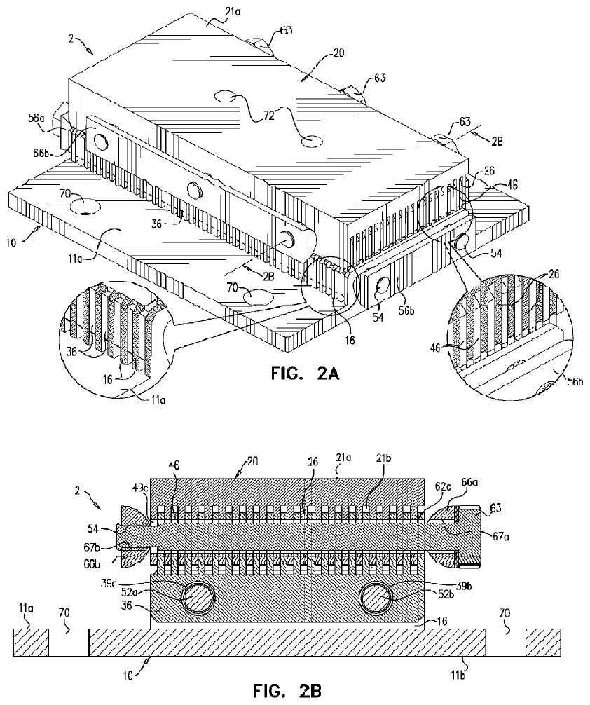

Turning to FIGS. 2A and 2B which are, respectively, a perspective view illustration and a sectional illustration of the heat sink 2, when assembled, the sectional illustration taken along section lines IIB-IIB in FIG. 2A, it is seen that the elongate leaves 16 of the first plate 10 are interlaced with the elongate leaves 36 of the first layer 32 of the intermediate plate 30, such that the bores 19a and 39a thereof are at least partially aligned, and the bores 19b and 39b thereof are at least partially aligned. Similarly, elongate leaves 26 of the second plate 20 are interlaced with elongate leaves 46 of the second layer 42 of the intermediate plate 30, such that bores 29a and 49a thereof are at least partially aligned, bores 29b and 49b thereof are at least partially aligned, and bores 29c and 39c thereof are at least partially aligned.

Rod 52a of locking assembly 50 extends through bores 57a of locking ruler 56a, the aligned (or aligned portion of) bores 19a and 39a, and bores 57b of locking ruler 56b. Similarly, rod 52b extends through bores 57a of locking ruler 56a, the aligned (or aligned portion of) bores 19b and 39b, and bores 57b of locking ruler 56b. As seen, heads 53 of rods 52a and 52b engage an exterior surface of locking ruler 56a. In some embodiments, such as the embodiment illustrated in FIGS. 2A and 2B, threaded portions 54 of rods 52a and 52b are screwed into threaded bores 57b. In other embodiments, such as the embodiment of FIGS. 3A and 3B, a threaded nut is screwed onto threaded portions 54 of rods 52a and 52b, exterior to ruler 56b. Locking rulers 56a and 56b are tightened to press the leaves 16 and 36 together such that the leaves at least partially engage or contact one another, and to prevent relative movement of first plate 10 and intermediate plate 30.

Similarly, rod 62a of locking assembly 60 extends through bores 67a of locking ruler 66a, the aligned (or aligned portion of) bores 29a and 49a, and bores 67b of locking ruler 66b. Similarly, rod 62b of locking assembly 60 extends through bores 67a of locking ruler 66a, the aligned (or aligned portion of) bores 29b and 49b, and bores 67b of locking ruler 66b, and rod 62c of locking assembly 60 extends through bores 57a of locking ruler 56a, the aligned (or aligned portion of) bores 29c and 49c, and bores 67b of locking ruler 66b. As seen, heads 63 of rods 62a, 62b, and 62c engage an exterior surface of locking ruler 66a. In some embodiments, such as the embodiment illustrated in FIGS. 2A and 2B, threaded portions 64 of rods 62a, 62b, and 62c are screwed into threaded bores 67b. In other embodiments, such as the embodiment of FIGS. 3A and 3B, a threaded nut is screwed onto threaded portions 64 of rods 62a, 62b, and 62c, exterior to ruler 66b. Locking rulers 66a and 66b are tightened to press the leaves 26 and 46 together such that the leaves at least partially engage or contact one another and to prevent relative movement of the second plate 20 and the intermediate plate 30.

Prior to connection of locking rulers 56a and 56b, the relative angle of first plate 10 and intermediate plate 30 along the first direction, indicated in FIG. 3B by the reference β, may be adjusted, such that the plates need not necessarily be absolutely parallel to one another, and may deviate from parallel alignment by a height indicated by D2, as shown in FIG. 3B. The connection of rulers 56a and 56b fixes the relative angle β, and prevents additional movement between the first plate 10 and the intermediate plate 30. Similarly, prior to connection of locking rulers 66a and 66b, the relative angle of second plate 20 and intermediate plate 30 along the second direction, indicated in FIG. 3A by the reference α, may be adjusted, such that the plates need not necessarily be parallel to one another, and may deviate from parallel alignment by a height indicated by D1, as shown in FIG. 3A. The connection of rulers 66a and 66b fixes the relative angle α, and prevents additional movement between the second plate and the intermediate plate. As such, an element, such as an optical element, disposed at face 21a of the second plate (i.e. above the second plate as shown in the drawings), may be accurately aligned at specific angles in three dimensions.

The alignment of plates 10, 30, and 20 relative to one another is determined by the user, when connecting the locking rulers 56a, 56b, 66a, and 66b to their respective rods. It is appreciated that in some embodiments, face 11a of first plate 10 and face 21a of plate 20 need not be parallel to one another, as illustrated in FIGS. 3A and 3B.

In operation, one of the first plate 10 and second plate 20 is heated and the other is cold, such that heat flows through the elongate leaves 16, 36, 46 and 26 from the hot plate to the cold plate, and the cold plate functions as a heat sink. Specifically, in some embodiments in which heat should be removed from an element disposed on face 21a of the second plate, heat flows from plate 20, via plate 30, to plate 10. Heat may further flow from first plate 10 into the base object to which plate 10 is attached, such as a table or other anchoring surface.

Although the drawings depict plates in which the leaves 16, 36, 46 and 26 are each of a respective uniform thickness 17, 37, 47 or 27, it will be appreciated that in principle the leaves on a given face of a plate may not all be of the same thickness, and that in such a case the spaces between the leaves on the opposite face will vary in accordance with variations in thickness of the leaves on the given face.

It will be appreciated that when reference is made to “an element to be cooled during use”, such element need not be in need of cooling at the time it is mounted to the heat sink.

It will be appreciated by persons of skill in the art the although sizes or distances mentioned herein may be described as being “the same” or “equal”, in practice in the manufacture of a heat sink as described herein, slight variations often occur. The degree to which such variations will be acceptable will be readily appreciated by persons skilled in the art, but generally will not be more than 5%, preferably not more than 3%, more preferably not more than 2%, still more preferably not more than 1%, yet more preferably not more than 0.5%.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention.

Section headings are used herein to ease understanding of the specification and should not be construed as necessarily limiting.

1. A heat sink kit including:
a first plate including a first plurality of elongate leaves, said elongate leaves of said first plurality being arranged in a first direction;
a second plate, including a second plurality of elongate leaves, said elongate leaves of said second plurality being arranged in a second direction, transverse to said first direction;
an intermediate plate including a first layer having a third plurality of elongate leaves and a second layer having a fourth plurality of elongate leaves, said elongate leaves of said third plurality being arranged in said first direction and said elongate leaves of said fourth plurality being arranged in said second direction,
wherein said elongate leaves of said first plurality are constructed and operative to be interlaced with said elongate leaves of said third plurality, and said elongate leaves of said second plurality are constructed and operative to be interlaced with said elongate leaves of said fourth plurality; and
first and second locking assemblies adapted to lock a position of said interlaced leaves,
wherein, prior to locking said position of said interlaced leaves, a relative orientation between said first and second plates is adjustable in three dimensions.

2. The heat sink kit of claim 1, wherein said elongate leaves of said first plurality are interlaced with said elongate leaves of said third plurality.

3. The heat sink kit of claim 2, wherein said first locking assembly locks a relative position of said interlaced elongate leaves of said first and third pluralities.

4. The heat sink kit of any one of claims 1 to 3, wherein said elongate leaves of said second plurality are interlaced with said elongate leaves of said fourth plurality.

5. The heat sink kit of claim 4, wherein said second locking assembly locks a relative position of said interlaced elongate leaves of said second and fourth pluralities.

6. The heat sink kit of any one of claims 1 to 5, wherein said leaves in said first plurality have a fixed first thickness, and each pair of adjacent leaves in said first plurality have a fixed first distance therebetween.

7. The heat sink kit of claim 6, wherein said leaves in said third plurality have a fixed third thickness, and each pair of adjacent leaves in said third plurality have a fixed third distance therebetween, said third thickness being equal to or smaller than said first distance, and said third distance being equal to or greater than said first thickness.

8. The heat sink kit of any one of claims 1 to 7, wherein said leaves in said second plurality have a fixed second thickness, and each pair of adjacent leaves in said second plurality have a fixed second distance therebetween.

9. The heat sink kit of claim 8, wherein said leaves in said fourth plurality have a fixed fourth thickness, and each pair of adjacent leaves in said fourth plurality have a fixed fourth distance therebetween, said fourth thickness being equal to or smaller than said second distance, and said fourth distance being equal to or greater than said second thickness.

10. The heat sink kit of any one of claims 6 to 9, wherein at least one of said first, second, third, and fourth thicknesses is in the range of 0.4 mm to 0.7 mm.

11. The heat sink kit of any one of claims 6 to 10, at least one of said first, second, third, and fourth thicknesses is 0.4 mm, 0.45 mm, 0.5 mm, 0.55 mm, 0.6 mm, 0.65 mm, or 0.7 mm.

12. The heat sink kit of claim 10 or claim 11, wherein at least one of said first, second, third, and fourth distances is in the range of 0.41 mm to 0.8 mm.

13. The heat sink kit of any one of claims 10 to 12, wherein at least one of said first, second, third, and fourth distances 0.41 mm, 0.45 mm, 0.5 mm, 0.55 mm, 0.6 mm, 0.65 mm, 0.7 mm, 0.75 mm, or 0.8 mm.

14. The heat sink kit of any one of claims 1 to 12, wherein each of said elongate leaves of said first and third pluralities includes at least one bore, wherein bores of said elongated leaves of said first and third pluralities are alignable with one another, and wherein said first locking assembly comprises at least one elongate rod adapted to extend through said bores of said interlaced leaves of said first and third pluralities when said bores are aligned, and to be locked therein, thereby to fix the relative position of said first plate and said intermediate plate.

15. The heat sink kit of claim 14, wherein said first locking assembly further comprises locking rulers adapted to lock said at least one elongate rod within said bores and to apply pressure to said interlaced leaves of said first and third pluralities, such that said interlaced leaves of said first and third pluralities contact one another.

16. The heat sink kit of claim 14, wherein said first locking assembly further comprises locking rulers including bores adapted accommodate said at least one elongate rod and nuts adapted to lock said at least one elongate rod within said bores and said locking rulers, said locking rulers adapted to apply pressure to said interlaced leaves of said first and third pluralities, such that said interlaced leaves of said first and third pluralities contact one another.

17. The heat sink kit of any one of claims 1 to 16, wherein each of said elongate leaves of said second and fourth pluralities includes at least one bore, wherein bores of said elongated leaves of said second and fourth pluralities are alignable with one another, and wherein said second locking assembly comprises at least one elongate rod adapted to extend through said bores of said interlaced leaves of said second and fourth pluralities when said bores are aligned, and to be locked therein, thereby to fix the relative position of intermediate plate and said second plate.

18. The heat sink kit of claim 17, wherein said second locking assembly further comprises locking rulers adapted to lock said at least one elongate rod within said bores and to apply pressure to said interlaced leaves of said second and fourth pluralities, such that said interlaced leaves of said second and fourth pluralities contact one another.

19. The heat sink kit of claim 17, wherein said second locking assembly further comprises locking rulers including bores adapted accommodate said at least one elongate rod and nuts adapted to lock said at least one elongate rod within said bores and said locking rulers, said locking rulers adapted to apply pressure to said interlaced leaves of said second and fourth pluralities, such that said interlaced leaves of said second and fourth pluralities contact one another.

20. The heat sink kit of any one of claims 1 to 19, wherein said first plate, said second plate, and said intermediate plate are formed of a heat conducting material.

21. The heat sink kit of claim 20, wherein said first, second, and intermediate plates are all formed of the same heat conducting material.

22. The heat sink kit of claim 20, wherein each of said first, second, and intermediate plates is formed of a different heat conducting material.

23. The heat sink kit of claim 20, wherein at least two of said first, second, and intermediate plates are formed of the same heat conducting material.

24. The heat sink kit of any one of claims 20 to 23, wherein said heat conducting material has a conductivity in the range of 100 W/mK to 500 W/mK, 150 W/mK to 450 W/mK, or 200 W/mK to 400 W/mK.

25. The heat sink kit of any one of claims 20 to 24, wherein a heat conductivity of at least one of said first and second locking assemblies is less than a heat conductivity of at least one of said first, second, and intermediate plates.

26. The heat sink kit of any one of claims 20 to 25, wherein said heat conducting material is a metal or an alloy.

27. The heat sink kit of claim 26, wherein said heat conducting metal or alloy comprises at least one of aluminum and copper.

28. The heat sink kit of any one of claims 1 to 27, wherein said first plate and said first plurality of leaves are manufactured together as an integrally formed unit.

29. The heat sink kit of any one of claims 1 to 28, wherein said second plate and said second plurality of leaves are manufactured together as an integrally formed unit.

30. The heat sink kit of any one of claims 1 to 29, wherein said intermediate plate and said third and fourth pluralities of leaves are manufactured together as an integrally formed unit.

31. The heat sink kit of any one of claims 1 to 30, further comprising an anchoring arrangement for anchoring said first plate to an anchoring surface.

32. The heat sink kit of any one of claims 1 to 31, further comprising a mounting arrangement for mounting an element to be cooled during use onto a face of said second plate distal to said first plate.

33. A kit including:
said heat sink kit of any one of claims 1 to 32; and
an element to be cooled during use, adapted to be mounted onto a face of one of said first and said second plates,
wherein said heat sink kit is adapted to remove heat from said element.

34. The kit of claim 33, wherein said element to be cooled during use comprises an optical element.

35. A method of constructing a heat sink for cooling a mounted element, using the heat sink kit of any one of claims 1 to 32, the method including at least one of:
using the first locking assembly to lock a relative position of the first and third plates; and
using the second locking assembly to lock a relative position of the second and third plates.

36. The method of claim 35, which includes both using the first locking assembly to lock a relative position of the first and third plates, and using the second locking assembly to lock a relative position of the second and third plates.

37. The method of claim 35 or claim 36, the method further including at least one of:
interlacing the elongate leaves of the first and third pluralities prior to using the first locking assembly to lock a relative position of the first and third plates; and
interlacing the elongate leaves of the second and fourth pluralities prior to using the second locking assembly to lock a relative position of the second and third plates.

38. The method of claim 37, which includes both interlacing the elongate leaves of the first and third pluralities prior to using the first locking assembly to lock a relative position of the first and third plates; and interlacing the elongate leaves of the second and fourth pluralities prior to using the second locking assembly to lock a relative position of the second and third plates.

39. The method according to any one of claims 35 to 38 of constructing a heat sink for cooling a mounted element, the method comprising:
interlacing said elongate leaves of said first and third pluralities;
using said first locking assembly to lock a relative position of said first and third plates;
interlacing said elongate leaves of said second and fourth pluralities;
using said second locking assembly to lock a relative position of said second and third plates.

40. The method of any one of claims 35 to 39, wherein the kit is a kit according to claim 32, further comprising mounting the element onto a face of said second plate using said mounting arrangement.

41. A method of constructing a heat sink for cooling an element, using the heat sink kit of claim 32, the method comprising:
at least one of (a) using the first locking assembly to lock a relative position of the first and third plates, and (b) using the second locking assembly to lock a relative position of the second and third plates; and
mounting the element onto a face of the second plate using the mounting arrangement.

42. The method of claim 41, which comprises both using the first locking assembly to lock a relative position of the first and third plates; and using the second locking assembly to lock a relative position of the second and third plates.

43. The method of claim 41 or claim 43, the method further comprising at least one of:
interlacing the elongate leaves of the first and third pluralities prior to using the first locking assembly to lock a relative position of the first and third plates; and
interlacing the elongate leaves of the second and fourth pluralities prior to using the second locking assembly to lock a relative position of the second and third plates.

44. The method of claim 43, which comprises both interlacing the elongate leaves of the first and third pluralities prior to using the first locking assembly to lock a relative position of the first and third plates, and interlacing the elongate leaves of the second and fourth pluralities prior to using the second locking assembly to lock a relative position of the second and third plates.

45. The method of any one of claims 41 to 44, which comprises:
interlacing said elongate leaves of said first and third pluralities;
using said first locking assembly to lock a relative position of said first and third plates;
interlacing said elongate leaves of said second and fourth pluralities;
using said second locking assembly to lock a relative position of said second and third plates; and
mounting the element onto a face of said second plate using said mounting arrangement.

46. A heat sink including:
a first plate including a first plurality of elongate leaves, said elongate leaves of said first plurality being arranged in a first direction;
a second plate, including a second plurality of elongate leaves, said elongate leaves of said second plurality being arranged in a second direction, transverse to said first direction;
an intermediate plate including a first layer having a third plurality of elongate leaves and a second layer having a fourth plurality of elongate leaves, said elongate leaves of said third plurality being arranged in said first direction and said elongate leaves of said fourth plurality being arranged in said second direction,
wherein said elongate leaves of said first plurality are interlaced with said elongate leaves of said third plurality, and said elongate leaves of said second plurality are interlaced with said elongate leaves of said fourth plurality;
a first locking assembly locking a relative position of said interlaced elongate leaves of said first and third pluralities; and
a second locking assembly locking a relative position of said interlaced elongate leaves of said second and fourth pluralities.

47. The heat sink of claim 46, wherein, prior to locking said position of said interlaced leaves, a relative orientation between said first and second plates is adjustable in three dimensions.

48. The heat sink of claim 46, wherein said leaves in said first plurality have a fixed first thickness, and each pair of adjacent leaves in said first plurality have a fixed first distance therebetween.

49. The heat sink of claim 48, wherein said leaves in said third plurality have a fixed third thickness, and each pair of adjacent leaves in said third plurality have a fixed third distance therebetween, said third thickness being equal to or smaller than said first distance, and said third distance being equal to or greater than said first thickness.

50. The heat sink of any one of claims 46 to 49, wherein said leaves in said second plurality have a fixed second thickness, and each pair of adjacent leaves in said second plurality have a fixed second distance therebetween.

51. The heat sink of claim 50, wherein said leaves in said fourth plurality have a fixed fourth thickness, and each pair of adjacent leaves in said fourth plurality have a fixed fourth distance therebetween, said fourth thickness being equal to or smaller than said second distance, and said fourth distance being equal to or greater than said second thickness.

52. The heat sink of any one of claims 48 to 51, wherein at least one of said first, second, third, and fourth thicknesses is in the range of 0.4 mm to 0.7 mm.

53. The heat sink of any one of claims 48 to 52, at least one of said first, second, third, and fourth thicknesses is 0.4 mm, 0.45 mm, 0.5 mm, 0.55 mm, 0.6 mm, 0.65 mm, or 0.7 mm.

54. The heat sink of claim 52, wherein at least one of said first, second, third, and fourth distances is in the range of 0.41 mm to 0.8 mm.

55. The heat sink of any one of claims 52 to 54, wherein at least one of said first, second, third, and fourth distances 0.41 mm, 0.45 mm, 0.5 mm, 0.55 mm, 0.6 mm, 0.65 mm, 0.7 mm, 0.75 mm, or 0.8 mm.

56. The heat sink of any one of claims 46 to 54, wherein each of said elongate leaves of said first and third pluralities includes at least one bore, wherein bores of said elongated leaves of said first and third pluralities are aligned with one another, and wherein said first locking assembly comprises at least one elongate rod extending through said bores of said interlaced leaves of said first and third pluralities and locked therein, thereby fixing the relative position of said first plate and said intermediate plate.

57. The heat sink of claim 56, wherein said first locking assembly further comprises locking rulers locking said at least one elongate rod within said bores and applying pressure to said interlaced leaves of said first and third pluralities, such that said interlaced leaves of said first and third pluralities contact one another.

58. The heat sink of claim 56, wherein said first locking assembly further comprises locking rulers including bores accommodating said at least one elongate rod and nuts locking said at least one elongate rod within said bores and said locking rulers, said locking rulers applying pressure to said interlaced leaves of said first and third pluralities, such that said interlaced leaves of said first and third pluralities contact one another.

59. The heat sink of any one of claims 46 to 58, wherein each of said elongate leaves of said second and fourth pluralities includes at least one bore, wherein bores of said elongated leaves of said second and fourth pluralities are aligned with one another, and wherein said second locking assembly comprises at least one elongate rod extending through said bores of said interlaced leaves of said second and fourth pluralities and locked therein, thereby fixing the relative position of intermediate plate and said second plate.

60. The heat sink of claim 59, wherein said second locking assembly further comprises locking rulers locking said at least one elongate rod within said bores and applying pressure to said interlaced leaves of said second and fourth pluralities, such that said interlaced leaves of said second and fourth pluralities contact one another.

61. The heat sink of claim 59, wherein said second locking assembly further comprises locking rulers including bores accommodating said at least one elongate rod and nuts locking said at least one elongate rod within said bores and said locking rulers, said locking rulers applying pressure to said interlaced leaves of said second and fourth pluralities, such that said interlaced leaves of said second and fourth pluralities contact one another.

62. The heat sink of any one of claims 46 to 61, wherein said first plate, said second plate, and said intermediate plate are formed of a heat conducting material.

63. The heat sink of claim 62, wherein said first, second, and intermediate plates are all formed of the same heat conducting material.

64. The heat sink of claim 62, wherein each of said first, second, and intermediate plates is formed of a different heat conducting material.

65. The heat sink of claim 62, wherein at least two of said first, second, and intermediate plates are formed of the same heat conducting material.

66. The heat sink of any one of claims 62 to 65, wherein said heat conducting material has a conductivity in the range of 100 W/mK to 500 W/mK, 150 W/mK to 450 W/mK, or 200 W/mK to 400 W/mK.

67. The heat sink of any one of claims 62 to 66, wherein a heat conductivity of at least one of said first and second locking assemblies is less than a heat conductivity of at least one of said first, second, and intermediate plates.

68. The heat sink of any one of claims 62 to 67, wherein said heat conducting material is a metal or an alloy.

69. The heat sink of claim 68, wherein said heat conducting metal or alloy comprises at least one of aluminum and copper.

70. The heat sink of any one of claims 46 to 69, wherein said first plate and said first plurality of leaves are manufactured together as an integrally formed unit.

71. The heat sink of any one of claims 46 to 70, wherein said second plate and said second plurality of leaves are manufactured together as an integrally formed unit.

72. The heat sink of any one of claims 46 to 71, wherein said intermediate plate and said third and fourth pluralities of leaves are manufactured together as an integrally formed unit.

73. The heat sink of any one of claims 46 to 72, further comprising an anchoring arrangement for anchoring said first plate to an anchoring surface.

74. The heat sink of any one of claims 46 to 73, further comprising a mounting arrangement for mounting an element to be cooled during use onto a face of said second plate distal to said first plate.

75. The heat sink of any one of claims 46 to 74, further comprising an element to be cooled during use mounted thereupon.

76. A kit including:
said heat sink of any one of claims 46 to 74; and
an element to be cooled during use, adapted to be mounted onto a face of one of said first and said second plates,
wherein said heat sink kit is adapted to remove heat from said element.

77. The kit of claim 76, wherein said element to be cooled during use comprises an optical element.
